(19) United States
(12) Patent Application Publication
(10) Pub. No.: US 2005/0129196 A1
(43) Pub. Date: Jun. 16, 2005

(54) Voice document with embedded tags

(75) Inventors: Thomas E. Creamer, Boca Raton, FL (US); Peeyush Jaiswal, Boca Raton, FL (US); Victor S. Moore, Boynton Beach, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/736,138

(22) Filed: Dec. 15, 2003

(51) Int. Cl. H04M 1/64; H04M 11/00

(52) U.S. Cl. 379/88.18; 379/88.22

(57) ABSTRACT

An digital audio file can include first digitized information specifying at least two types of audio content and second digitized information specifying a set of tags. The set of tags can include an opening tag indicating a beginning location within the audio file of a type of content and a closing tag indicating an ending location within the audio file of the type of content. The set of tags is associated with the type of audio content for which the set of tags indicates a beginning and an end.

### BACKGROUND

1. Field of the Invention

The invention relates to the field of audio documents or recordings and, more particularly, to the inclusion of tags within audio documents or recordings.

2. Description of the Related Art

A digital recording, for example an audio file such as a Wave, Audio Interchange File Format (AIFF), MPEG Audio Layer 3 (MP3), or MP4 file, can store various types of audio content. For instance, digital recordings can store music, speech, sound effects, and the like. When testing voice response systems, the audio that is exchanged between a user or test system and the voice response system can be captured in such a digital recording for later examination. Although the digital recording can include various forms of audio content, at present, there is no way of demarcating one type of content from other types of audio content that may be included within the same digital recording or audio file.

For example, in the context of testing a voice response system, a digital recording of a user session with the voice response system would include both user spoken requests as well as voice prompts from the voice response system. What is needed is a way in which different types of audio content can be marked within a single digital recording or audio file.

### SUMMARY OF THE INVENTION

The present invention provides a method, system, and apparatus for marking various types of audio content within audio files. In accordance with the inventive arrangements disclosed herein, audio tags can be included within an audio file to isolate and identify different types of audio content. The audio tags can be user definable and provide an organization to the audio file.

One aspect of the present invention can include a method of indicating content within an audio file. The method can include defining a set of audio tags including an opening tag and a closing tag, associating each set of audio tags with a type of content, marking a starting location of a type of content within the audio file using the opening tag, and marking an ending location of the type of content within the audio file using the closing tag.

The opening tag and closing tag can be specified by tones and/or waveform shapes. In one embodiment, the audio file can be a digitized voice file. For example, the type of content can include at least one of a voice prompt or a user response.

Another aspect of the present invention can include an audio file. The audio file can include first digitized information specifying at least one type of audio content within the audio file. The audio file further can include second digitized information specifying a set of tags. The set of tags can include an opening tag indicating a beginning location within the audio file of a type of audio content and a closing tag indicating an ending location within the audio file of the type of audio content. The set of tags is associated with the type of audio content for which the set of tags indicates a beginning and an end.

The set of tags can be defined by tones and/or waveforms shapes. In one embodiment, the audio file can be a digitized voice file. The type of content can be a voice prompt type and/or a user response type.

In another embodiment, the second digitized information can specify a plurality of tag sets indicating an organization of a plurality of content types included within the audio file. Notably, the content types further can be hierarchically ordered using the plurality of tag sets.

Other embodiments of the present invention can include a system having means for performing the various steps disclosed herein and a machine readable storage for causing a machine to perform the steps described herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a digital audio processor for including audio tags within a digital audio file in accordance with one embodiment of the present invention.

FIG. 2 is an exemplary representation of a digital audio file including audio tags in accordance with the inventive arrangements disclosed herein.

FIG. 3 is a representation of an exemplary waveform after insertion of audio tags in accordance with one embodiment of the present invention.

### DETAILED DESCRIPTION OF THE INVENTION

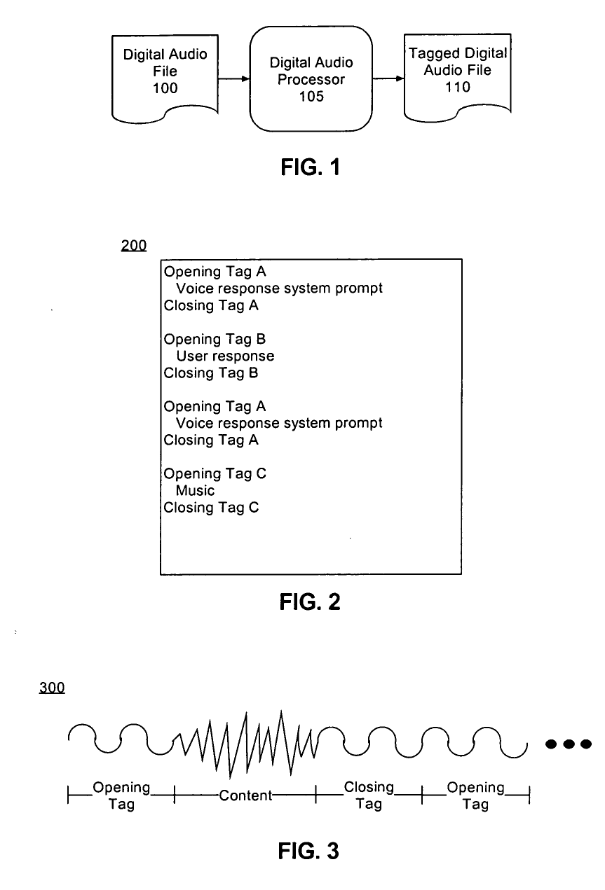

FIG. 1 is a schematic diagram illustrating a digital audio processor 105 for including audio tags within a digital audio file 100 in accordance with one embodiment of the present invention. The digital audio processor 105 can be implemented as a computer program executing within an information processing system. The digital audio processor 105 can insert audio tags within the digital audio file 100.

The audio tags, similar in purpose to Extensible Markup Language (XML) tags, can be used to set off different types of audio content within the digital audio file 100. As such, the audio tags can be distinguished from the audio content the audio tags are marking or identifying. The audio tags can be composed of one or more tones, which can be identifiable and used to indicate the beginning and end of particular types of audio content. The sets of audio tags can be defined and associated with various types of audio content. Examples of audio content can include, but are not limited to, speech or dialog and music. Still, other examples can include more specific cases of larger content domains. For instance, speech can be subdivided into further content types such as “user response” and “voice response system prompt.”

Accordingly, the digital audio processor 105 can receive the digital audio file 100 and process the file to include audio tags as appropriate. The resulting tagged digital audio file 110 can be provided by the digital audio processor 105 as output. In one embodiment, the digital audio processor 105 can analyze various aspects of the digital audio file to automatically detect possible changes in content. Such determinations can be performed using frequency analysis to distinguish between different persons that may be speaking in the digital recording or using speech recognition to distinguish spoken portions from music or other non-spoken audio content. Any of a variety of known digital signal processing techniques can be used to determine possible transitions between types of audio content within the digital audio file 100.

In another embodiment, the digital audio processor 105 can provide a graphical user interface (GUI) to present a graphical representation of the waveform specified by the digital recording or file. Through such a GUI, a user can indicate beginning and ending audio tag positions to denote beginning and ending locations of various types of content within the audio file. The user can use any of a variety of input mechanisms to interact with such a GUI.

In yet another embodiment, the digital audio processor 105 can play the digital audio file 100. In that case, a user can provide an input to the system to indicate where each audio tag is to be placed when a transition between two types of audio content is heard and detected. Those skilled in the art will recognize, however, that the present invention can include various combinations of the automated tagging process, the GUI-based user initiated process, as well as the playback-based user initiated process for adding audio tags to the digital audio file 100.

FIG. 2 is an exemplary representation of a digital audio file 200 or recording in accordance with the inventive arrangements disclosed herein. As shown, the digital audio file includes three sets of audio tags: A, B, and C. Each set of audio tags includes an opening tag and a closing tag used to separate various types of audio content from one another within the digital audio file 200.

The digital audio file 200 includes three different types of content: voice response system prompts, user responses, and music. Each of the audio tag sets has been associated with a particular type of content. For example, voice response system prompts have been associated with audio tag set A, user responses have been associated with audio tag set B, and music has been associated with audio tag set C.

While the audio tag sets are shown as being letters or a series of characters, as noted, the audio tags of the present invention can be actual portions of audio. For example, identifiable tones of a particular frequency or dominant frequency or other audio identifiers such as particular waveforms, i.e. sinusoidal, saw-tooth, square waves, or a combination thereof, can be used as audio tags. In another embodiment, the audio tags can be sub-audio or touch tones (dual tone multi-frequency tones), or a series of tones. In any case, the audio tags can be user definable and give meaning and order to the digital audio file 200.

The opening and closing audio tags can be different from one another or can be the same. For example, if tones are used, the opening tag and closing tag can be the same tone, or can be different, but paired tones, such that one tone is designated as the opening tag and the other different tone is designated as the closing tag. Thus, different types of audio content within the digital audio file can be identified using leading and trailing tone markers to isolate each audio content type.

Use of audio tags as disclosed herein further allows the various content types, that is the isolated portions of audio or components of the digital audio file, to be arranged in a hierarchical format. For example, in the case of voice, one voice sequence can be marked or tagged as a command, while another is marked as the response expected from the issuance of the voice command. Accordingly, the various components of the digital audio file can then be arranged or ordered according to audio content type. In another example, the present invention can be used to identify one sequence of words as a command and another sequence of words as attributes for the command. The present invention allows complicated test sequences to be described within the digital audio file.

The audio file representation 200 is provided as an example of the use of audio tags. Those skilled in the art will recognized that as the audio tags can be user definable, the audio tags can represent or indicate any of a variety of different audio content types.

FIG. 3 is a representation of an exemplary waveform 300 after insertion of audio tags in accordance with one embodiment of the present invention. As shown, the opening and closing tags demarcate the content component. In this case the opening and closing tags are sinusoidal waveforms having particular frequencies. Although the opening and closing tags are shown as having the same frequency, as noted, the opening and closing tags can be different, but paired or assigned as indicating a particular type of content. In any case, the waveform 300 is provided only as an illustration of the use of audio tags within an audio file and is not intended as a limitation of the inventive arrangements disclosed herein.

The present invention allows a tagged audio file to be read or played such that the playback system can determine the content within the audio file based upon an interpretation of the audio tags detected therein.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method of indicating content within an audio file comprising:
defining a set of audio tags comprising an opening tag and a closing tag;
associating the set of audio tags with a type of content;
marking a starting location of a type of content within the audio file using the opening tag; and
marking an ending location of the type of content within the audio file using the closing tag.

2. The method of claim 1, wherein the opening tag and closing tag are specified by tones.

3. The method of claim 1, wherein the opening tag and closing tag are specified by waveform shapes.

4. The method of claim 1, wherein the audio file is a digitized voice file.

5. The method of claim 1, wherein the type of content includes at least one of a voice prompt or a user response.

6. An audio file comprising:
first digitized information specifying at least one type of audio content within the audio file; and
second digitized information specifying a set of tags, wherein said set of tags comprises an opening tag indicating a beginning location within the audio file of a type of audio content and a closing tag indicating an ending location within the audio file of the type of audio content;
wherein said set of tags is associated with the type of audio content for which said set of tags indicates a beginning and an end.

7. The audio file of claim 6, wherein said set of tags are defined by tones.

8. The audio file of claim 6, wherein said set of tags are defined by waveform shapes.

9. The audio file of claim 6, wherein the audio file is a digitized voice file.

10. The audio file of claim 6, wherein the type of audio content is a voice prompt type or a user response type.

11. The audio file of claim 6, wherein said second digitized information specifies a plurality of tag sets indicating an organization of a plurality of content types included within said audio file.

12. The audio file of claim 11, wherein the content types are hierarchically ordered using said plurality of tag sets.

13. A system for indicating content within an audio file comprising:
means for defining a set of audio tags comprising an opening tag and a closing tag;
means for associating the set of audio tags with a type of content;
means for marking a starting location of content within the audio file using the opening tag; and
means for marking an ending location of the content within the audio file using the closing tag.

14. The system of claim 13, wherein the opening tag and closing tag are specified by tones.

15. The system of claim 13, wherein the opening tag and closing tag are specified by waveform shapes.

16. The system of claim 13, wherein the audio file is a digitized voice file.

17. The system of claim 13, wherein the type of audio content is a voice prompt type or a user response type.

18. The system of claim 13, wherein said second digitized information specifies a plurality of tag sets indicating an organization of a plurality of content types included within said audio file.

19. The system of claim 18, wherein the content types are hierarchically ordered using said plurality of tag sets.

20. A machine readable storage, having stored thereon a computer program having a plurality of code sections executable by a machine for causing the machine to perform the steps of:
defining a set of audio tags comprising an opening tag and a closing tag;
associating the set of audio tags with a type of content;
marking a starting location of content within the audio file using the opening tag; and
marking an ending location of the content within the audio file using the closing tag.

21. The machine readable storage of claim 20, wherein the opening tag and closing tag are specified by tones.

22. The machine readable storage of claim 20, wherein the opening tag and closing tag are specified by waveform shapes.

23. The machine readable storage of claim 20, wherein the audio file is a digitized voice file.

24. The machine readable storage of claim 20, wherein the type of audio content is a voice prompt type or a user response type.

25. The machine readable storage of claim 20, wherein said second digitized information specifies a plurality of tag sets indicating an organization of a plurality of content types included within said audio file.

26. The machine readable storage of claim 25, wherein the content types are hierarchically ordered using said plurality of tag sets.
